(19) United States
(12) Patent Application Publication
(10) Pub. No.: US 2019/0109489 A1
(43) Pub. Date: Apr. 11, 2019

(54) MODULAR POWER DISTRIBUTION SYSTEM & CONTROLS

(71) Applicant: RideController LLC, Mission, KS (US)

(72) Inventor: Andrew Miller, Mission, KS (US)

(73) Assignee: RideController LLC, Mission, KS (US)

(21) Appl. No.: 16/142,746

(22) Filed: Sep. 26, 2018

Related U.S. Application Data
(60) Provisional application No. 62/568,442, filed on Oct. 5, 2017.
(60) Provisional application No. 62/714,493, filed on Aug. 3, 2018.

(51) Int. Cl. H02J 13/00; G05B 15/02

(52) U.S. Cl. CPC H02J 13/0003; G05B 15/02

(57) ABSTRACT

A modular power distribution system and method therefor. The system includes a core module in addition to first and second modules. The modules each have a wired communication interface coupled to a communication network. The first module sends a first signal to the second module via network and in turn the second module alters an electrical output thereof to control an electrical device based on the first signal. The core module monitors the network for the first signal and determines a state of the electrical output of the second module by comparing the first signal to a ruleset. Based on the first signal and the ruleset, the core module communicates a second signal representative of the determined state to the computing device via a wireless communication interface.

### CROSS-REFERENCE TO RELATED APPLICATIONS

This application claims priority from U.S. Provisional Patent Application No. 62/568,442, filed Oct. 5, 2017, and from U.S. Provisional Patent Application No. 62/714,493, filed Aug. 3, 2018. The entire contents of the above-identified applications are expressly incorporated herein by reference, including the contents and teachings of any references contained therein and appendices thereto.

### TECHNICAL FIELD

Aspects of the present disclosure generally relate to systems and methods for managing direct current distribution.

### BACKGROUND

Many direct current power distribution systems known in the art use magnetic relays and external fuses to handle all fault protection. These systems are often custom built for a specific desired application in the field. Disadvantages of these conventional systems include, for example, extensive labor and cost involved in adding components, limited to a single external input, and limited to local, wired control of the system.

### SUMMARY

Aspects of the disclosure include a modular network and control system that enables control of direct current devices. Along with control, the modular direct current power control system includes integrated safety features to protect itself and devices that are connected thereto from electrical damage. Aspects of the system are configured to be controlled from a smartphone, tablet, dedicated control panel, external physical controls and/or any other external application programming interface. In one form, aspects of the disclosure include: modular expansion, multiple external inputs, wireless connectivity, and an application programming interface to control the system.

In one form, the system is comprised of a communications network 135, a core processing communication module (e.g., a “Core”) 100, a direct current distribution control module 105 (e.g., a “PowerPack”), an external input trigger module (e.g., a “SwitchPack”) 160, a LED lighting control module (e.g., a “ColorPack”) 110, a suspension control module (e.g., a “RidePack”) 115, a dedicated touchscreen 120, one or more user mobile devices 130, and an application server 125. The core processing communication module (e.g., a “Core”) 100 will be the main processing control point, it will provide access and control methods to manage all modules attached to the network such as direct current distribution control module 105 (e.g., a “PowerPack”), LED lighting control module (e.g., a “ColorPack”) 110, suspension control module (e.g., a “RidePack”) 115, external input trigger module (e.g., a “SwitchPack”) 160 and future modules that will offer expanded direct current control. These modules will then be connected to direct current devices such as (lighting, electric motors, actuators, valves, switches, etc).

Implementation of the described system will include hardware, a method or process implemented at least partially in the hardware, and software that implements a method or process to send and receive information from the hardware network. Said software may run on a smartphone, tablet, dedicated touchscreen control system, smart physical switches, or remote via web based access.

The details of one or more implementations are set forth in the accompanying drawings and description below. Other features will be apparent from the description and drawings.

### DESCRIPTION OF DRAWINGS

FIG. 1 illustrates a block diagram of a system according to an embodiment.

FIG. 2 illustrates fitment options of the system of FIG. 1.

FIG. 3 illustrates an example of a process for use of power distribution system and controls.

FIG. 4 illustrates an example of a software application running on a mobile device to control a hardware power distribution system.

FIG. 5 is a block diagram of exemplary circuitry of a core processing communication module.

FIG. 6 is a block diagram of exemplary circuitry of a direct current distribution control module with a bus bar.

FIG. 7A-7C illustrate an example of user mobile device(s) and a dedicated touch screen and how they interact with a DC Power System to control DC devices via a direct current distribution control module.

FIG. 8 illustrates an example of how an LED lighting control module receives commands and controls LED lighting.

FIG. 9 illustrates an example of how a suspension control module receives commands and controls a suspension system.

FIG. 10 illustrates an example of how an external input trigger module sends a command to a communication network and how other modules on the system interact with that command.

Corresponding reference characters indicate corresponding parts throughout the drawings.

### DETAILED DESCRIPTION

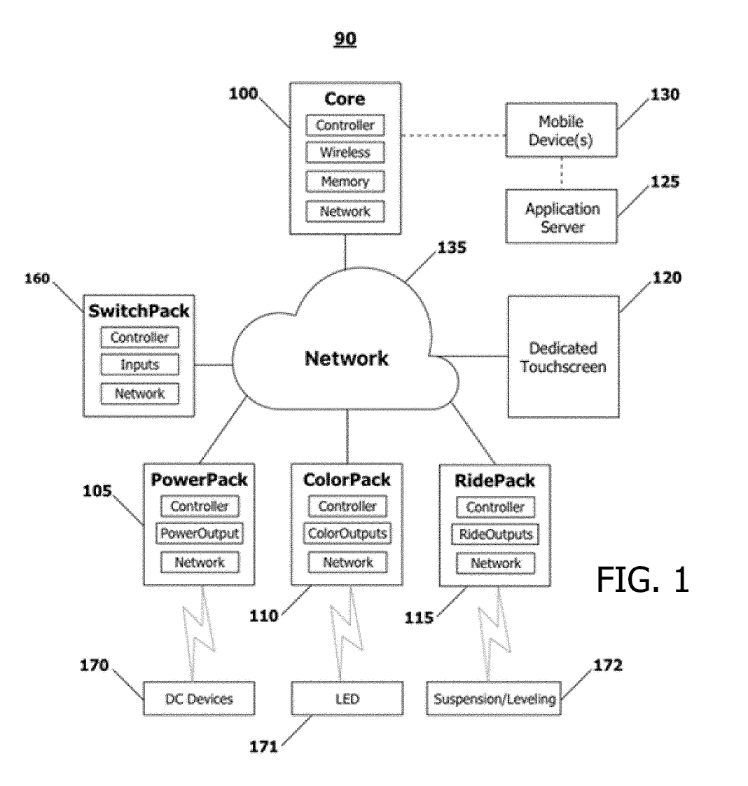

FIG. 1 illustrates a block diagram of an exemplary direct current management system 90 configured to manage a direct current electrical system. The direct current management system 90 includes a communications network 135, a core processing communication module (e.g., a “Core”) 100, a direct current distribution control module 105 (e.g., a “PowerPack”), an external input trigger module (e.g., a “SwitchPack”) 160, a LED lighting control module (e.g., a “ColorPack”) 110, a suspension control module (e.g., a “RidePack”) 115, a dedicated touchscreen 120, one or more user mobile devices 130, and an application server 125. In an embodiment, the core processing communication module 100, the direct current distribution control module 105, the LED lighting control module 110, the suspension control module 115, the dedicated touchscreen 120, and the external input trigger module 160 are electrically and/or communicatively coupled to each other via the communications network 135. In another embodiment, the user mobile devices 130 and/or application server 125 are electrically and/or communicatively coupled to the core processing communication module 100 via a telecommunications network that facilitates the exchange of data (e.g., via the IEEE 802.15 (e.g., Bluetooth) protocol), as further described herein.

The network 135 is configured to facilitate the exchange of electronic communication (e.g., data) between devices connected to the network 135. For example, the network 135 may be configured to enable the exchange of electronic communication between two or more components of direct current management system 90, including the core processing module 100 (Core), the external input trigger module (SwitchPack) 160, the direct current distribution control module (PowerPack) 105, the LED lighting control module (ColorPack) 110, the suspension control module (RidePack) 115, and the dedicated touchscreen 120. The network 135 may include, for example, a Controller Area Network (CAN) bus, and/or serial communication for carrying data. The network 135 may include a wired network, wireless network, combination of both, or any other network able to transmit and receive electronic communication. The communications network 135 may be any telecommunications network that facilitates the exchange of data, such as those that operate according to the IEEE 802.3 (e.g., Ethernet), the IEEE 802.11 (e.g., Wi-Fi), and/or the IEEE 802.15 (e.g., Bluetooth) protocols, for example. In another embodiment, communications network 135 is any medium that allows data to be physically transferred through serial or parallel communication channels (e.g., copper wire, optical fiber, computer bus, wireless communication channel, etc.).

The external input trigger module 160 (SwitchPack) includes a processor, a network module, and one or more input receivers. The network module is configured to electrically and/or communicatively couple the external input trigger module 160 to the network 135. The external trigger module 160 (SwitchPack) is configured to receive external inputs (e.g., via the input receivers) and translate them (e.g., via the processor) into commands passed on to the network 135 (e.g., via the network module) to be executed on one or more modules described herein, such as the direct current distribution control module (PowerPack) 105. The inputs would come in the form of a direct current positive wire. This would allow for a physical switch to wire into the input receiver on the external input trigger module 160 (SwitchPack). The input receiver is custom circuitry that is power current sensing. Once it senses power current on one of the multiple input pins the processor will execute a command to pass on to the network 135. In some embodiments, the controller 160 includes a processor and/or other control circuitry configured to receive external input and send instructions to the network 135. All modules 105, 110, 115, 120, and 100 connected to the network 135 will see instructions executed by the external input trigger module (SwitchPack) 160 via the network 135 and perform (e.g., execute) said instructions. In an embodiment, the modules 105, 110, 115, 120, and 100 perform instructions addressed thereto. In an embodiment, external trigger module 160 comprises processor-executable instructions embodied on a storage memory device of a computing device to perform the functions described herein via a software environment. For example, external trigger module 160 may be provided as processor-executable instructions that comprise a procedure, a function, a routine, a method, and/or a subprogram utilized independently or in conjunction with additional aspects of system 90 according to an exemplary embodiment of the disclosure.

The core processing module 100 (Core) includes a processor, network module, a wireless communications module, and a memory device. In an embodiment, core processing module 100 includes control circuitry configured to execute instructions of a program that controls modules on the network 135. Said modules such as 160, 105, 110, 115, 120, 100 and any other modules connected to the network 135 are configured to receive these commands and run additional programs (e.g., execute processor-executable instructions) to perform actions to direct current controlled devices. In another embodiment, the core processing module 100 (Core) is configured to send data to and receive data from user mobile devices 130 over a wireless data channel. The core processing module 100 (Core) may include one or more of a, Bluetooth module, LTE module, GSM module, and/or any type of module configured to exchange communication in one of the following formats: Bluetooth, LTE, GSM or GPRS, CDMA, EDGE or EGPRS, EV-DO, WIFI, or IP. The core processing module 100 (Core) is configured to send commands, errors, status, and current state of all modules on the network 135 back to the user mobile devices 130. User Mobile devices 130 are configured to send commands to the core processing module 100 (Core) over the wireless network to execute desired actions. These commands will be executed via a custom program on the user mobile devices 130 that will be sent to the core processing module 100 (Core) for interpretation, which will then execute instructions to the network on desired actions to be performed. In an embodiment, core processing module 100 comprises processor-executable instructions embodied on a storage memory device of a computing device to perform the functions described herein via a software environment. For example, core processing module 100 may be provided as processor-executable instructions that comprise a procedure, a function, a routine, a method, and/or a subprogram utilized independently or in conjunction with additional aspects of system 90 according to an exemplary embodiment of the disclosure.

The core processing module 100 (Core) network module, in one or more exemplary embodiments, will include an external antenna configured to transmit wireless data between the core processing module 100 (Core) and user mobile devices 130. The core processing module 100 (Core) will also include one or more temperature sensors and/or any other type of sensor (e.g., vibration, temperature, humidity, voltage, light intensity, microphones, etc.). These sensors will be useful for detecting the overall health and external environment the system is in. The core processing module 100 (Core) in some configurations will have the capability to connect to a Application Server (125) or User Mobile Devices 130 to download firmware updates over the air via a LTE. The firmware updates will apply to the core processing module 100 (Core) and may also apply to other modules on the network 135 such as 160, 110, 115, 105 120, 130.

In addition, the core processing module 100 (Core) may store data that describes the attributes, security information, names for direct current devices 170 attached to system, icons for direct current devices 170, and/or modules connected to the network 135. This data will be stored in one or more electronic storage mediums on the custom circuitry. These data(s) attributes will be shared via the core processing module 100 (Core) on the network 135 and distributed to all modules on the network 135 such as 160, 110, 115, 105 120, 130, in additional said data will be transmitted wirelessly via the core processing module 100 (Core) to user mobile devices 130.

The direct current distribution control module 105 (PowerPack) includes a processor, network module, power outputs, input sensors, and custom circuitry configured to execute instructions of a program that listens on the network 135 for commands that need to be executed by the direct current distribution control module 105. The direct current power distribution control module 105 (PowerPack) will send status messages at set intervals based on input sensor readings back to other modules on the network 135. The direct current distribution module 105 (PowerPack) is configured to be electrically and/or communicatively coupled (e.g., wired) to direct current powered devices (e.g., LED lights, electric motors, solenoids, winches, actuators, etc.), which enables the direct power distribution control module 105 (PowerPack) to perform desired actions. The direct current distribution control module 105 (PowerPack) is configured to communicate state information (e.g., current state, etc.) back to other modules on the network 135. This will enable the core processing module 100 (Core) to read error codes and/or current state of direct current powered devices (e.g., LED lights, electric motors, solenoids, winches, actuators, etc.) wired to the direct current distribution control module 105 (PowerPack). The direct current power distribution module 105 (PowerPack) includes one or more temperature sensors and/or any other types of sensor (e.g., vibration, digital input, fluid level, 0-5 VDC, temperature, humidity, voltage, light intensity, microphones, etc.). These sensors will be useful for detecting the overall health and external environment the system is in. The direct current distribution control module 105 (PowerPack) includes circuitry that allows for high power outputs that are self healing in the case of a direct current accessory drawing more power than what the output is rated for. In an embodiment, direct current distribution control module 105 comprises processor-executable instructions embodied on a storage memory device of a computing device to perform the functions described herein via a software environment. For example, direct current distribution control module 105 may be provided as processor-executable instructions that comprise a procedure, a function, a routine, a method, and/or a subprogram utilized independently or in conjunction with additional aspects of system 90 according to an exemplary embodiment of the disclosure.

The LED lighting control module (ColorPack) 110 includes a processor, network module, and custom circuitry configured to control color changing light-emitting diode(s). The custom circuitry is configured to execute instructions of a program that listens on the network 135 for commands that need to be executed. The LED lighting control module (ColorPack) 110 may also include one or more temperature sensors and/or any other type of sensor (e.g., vibration, temperature, humidity, voltage, light intensity, microphones, etc.). These sensors will be useful for detecting the overall health and external environment the system is in. The LED lighting control module (ColorPack) 110 is configured to be electrically coupled (e.g., wired) directly to LED Devices 171. The LED lighting control module (ColorPack) 110 is configured to communicate state information (e.g., current state, etc.) back to other modules on the network 135. This will allow the core processing module 100 (Core) to read error codes and current state of LED Devices 171 wired to the LED lighting control module (ColorPack) 110. In an embodiment, LED lighting control module (ColorPack) 110 comprises processor-executable instructions embodied on a storage memory device of a computing device to perform the functions described herein via a software environment. For example, LED lighting control module (ColorPack) 110 may be provided as processor-executable instructions that comprise a procedure, a function, a routine, a method, and/or a subprogram utilized independently or in conjunction with additional aspects of system 90 according to an exemplary embodiment of the disclosure.

In additional or alternative embodiments, the LED lighting control module (ColorPack) 110 includes a connected microphone. The connected microphone will be used to pick up sound. The custom circuitry on the LED lighting control module (ColorPack) 110 will receive this sound (e.g., the electrical representation of this sound from the connected microphone) and then change the ColorOutputs to sync to one or more properties of the sound (e.g., the rhythm, decibel level, beats per minute, etc.) being measured by the microphone.

The suspension control module (RidePack) 115 includes a processor, network module, and custom circuitry configured to control devices related to suspension control on a vehicle and/or a leveling system. The custom circuitry is configured to execute instructions of a program that listens on the network 135 for commands that need to be executed. The suspension control module (RidePack) 115 is electrically coupled (e.g., wired) directly via direct current power inputs into a valve and/or relay system that is then wired to said Suspension/Leveling system 172. The suspension control module (RidePack) 115 includes sensor inputs to read data and signals coming back from suspension/leveling system 172. The suspension control module (RidePack) 115 will then receive the input and execute instructions based on a program on its processor to perform an action on the RideOutputs on the suspension control module (RidePack) 115. This sensor data will be passed on to the network 135 so that the core processing module 100 (Core) will process and then pass on information to Dedicated Touchscreen 120, User Mobile Devices 130. In an embodiment, suspension control module (RidePack) 115 comprises processor-executable instructions embodied on a storage memory device of a computing device to perform the functions described herein via a software environment. For example, suspension control module (RidePack) 115 may be provided as processor-executable instructions that comprise a procedure, a function, a routine, a method, and/or a subprogram utilized independently or in conjunction with additional aspects of system 90 according to an exemplary embodiment of the disclosure. Above system may also exemplify an embodiment to self level a marine vessel via its ballast tank system.

In an exemplary embodiment, the dedicated touchscreen 120 (e.g., a device configured to only run one or more predefined apps, a touchscreen comprising an infotainment system in a vehicle or other permanent screen system, etc.) is configured to directly connect to the network 135. The dedicated touchscreen 120 runs custom software that is executed to pass commands on to the network 135. The dedicated touchscreen 120 is also configured to receive commands and sensor information from the network 135. Commands sent from the dedicated touchscreen 120, will be sent on the network 135 to the modules on the network 135 to perform said command on direct current devices 170, 171, 172 that are attached to modules such as 105, 110, 115, and 100. The core processing module 100 (Core) may listen to specific commands from the dedicated touchscreen 120 and broadcast them back to one or more mobile user devices 130. In one or more embodiments, the dedicated touchscreen 120, may be configured to connect to an existing 3rd party vehicle network to send and receive commands that do not take place on the network 135. For example the dedicated touchscreen 120, in an embodiment could connect to a vehicle or engine factory communication network to read factory sensors, and to send factory commands to the system to do actions such as start engine, turn on headlights, unlock doors, turn on motor, turn on boat bilge bump, turn on exterior lighting, engage 4 wheel drive, set engine computer mode to performance mode, read engine rpm, read engine temperature, read engine battery voltage and the like. The extra set of instructions and commands that will be passed on to this 3rd party network will allow the dedicated touchscreen 120 to process commands, send commands, read sensors, and read data passing along the 3rd party network. These 3rd party networks may exist on any machines such as vehicles, off-road vehicles, automobiles, recreational vehicles, agriculture equipment, boats, emergency response vehicles, and industrial equipment to name a few.

The one or more user mobile devices 130. In one or more exemplary embodiments, mobile devices 130 are configured to connect to the core processing module 100 (Core) wirelessly. Communication occurs between the user mobile devices 130 and the core processing module 100 (Core) over a wireless medium such as Bluetooth, Wifi, LTE, GSM, CDMA, and/or any other type of wireless communication medium. Alternatively, user mobile device 130 supports a direct wired connection to the core processing module 100 (Core) and/or network 135 that will enable it to communicate with core processing module (Core) 100. The user mobile devices 130 are configured to run a custom native application that communicates wirelessly with the core processing module 100 (Core). Data will flow both directions with the core processing module 100 (Core) sending status data and error data back to the user mobile devices 130 and the user mobile devices 130 sending commands to the core processing module 100 (Core). Commands passed from the user mobile devices 130 to the core processing module (100), then on to the network 135 to its target modules such as 105, 110, 115, and 100. One or more user mobile devices 130 may be associated with a core processing module 100 (Core). For example, the one or more user mobile devices 130 may be smartphones, tablets, personal computers, and other types of network—wireless devices.

In an embodiment, the core processing module 100 (Core) is configured to monitor battery voltage on a power source (e.g., DC power source 205). In one or more exemplary embodiments, the core processing module executes instructions which configure it to shutdown and disable any attached module on the network 135 to protect the DC power source 205 from excessive discharge. If the set of instructions on the core processing module 100 (Core) deems it necessary to protect DC power source 205 it may also shut down itself being the core processing module 100 (Core). In an embodiment, outputs of DC power source 205 are wired to control an alternating current (AC) relay, which enables control of AC power devices.

In one or more embodiments, the core processing module 100 (Core), may be configured to connect to an existing 3rd party vehicle network to send and receive commands that do not take place on the network 135. For example the core processing module 100 (Core), in an embodiment could connect to a vehicle factory communication network to read factory sensors, and to send factory commands to the system to do actions such as start engine, turn on headlights, unlock doors, turn on motor, turn on boat bilge bump, turn on exterior lighting, engage 4 wheel drive, set engine computer mode to performance mode, and the like. The extra set of instructions and commands that will be passed on to this 3rd party network will allow the core processing module 100 (Core) to process commands, send commands, read sensors, and read data passing along the 3rd party network. These 3rd party networks may exist on any machines such as vehicles, off-road vehicles, automobiles, recreational vehicles, agriculture equipment, boats, emergency response vehicles, and industrial equipment to name a few.

The Application Server (125) is configured to store and deliver data that cannot be stored on the core processing module (100). This server will be accessed via user mobile devices 130 using an LTE internet connection. This Application Server (125) will be used to store custom icons, fav settings, and misc data related to the native application running on user mobile devices (130).

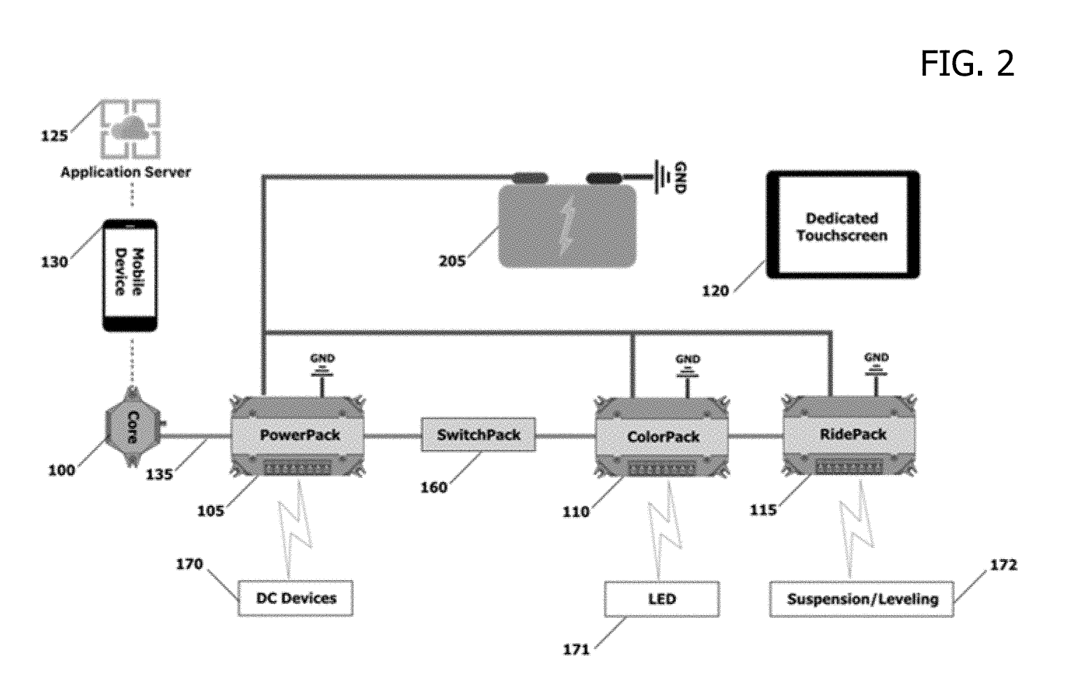

FIG. 2. Illustrates a block diagram of an exemplary modular power distribution system. The components of the system 90 as depicted in FIG. 1 are configured to perform operations on a direct power distribution system 90. For instance, the core processing module (100) is configured to process and execute commands that are passed on to the network 135. Once on the network 135, the commands are delivered to the target modules, such as one or more of modules 105, 110, 115, 160, 100, which are configured to then perform the required operation. The direct power distribution system will be electrically coupled (e.g., wired) to a power source, such as, for instance, DC power source 205, that it will manage. In an exemplary embodiment, DC power source 205 is an automotive battery configured to supply electrical energy to a vehicle (e.g., car, truck, bus, motorcycle, off-road vehicle, all-terrain vehicle, recreational vehicle (RV), agricultural equipment, boats, airplanes, unmanned aerial vehicles, emergency response vehicles, etc.).

In an exemplary embodiment, the core processing module 100 (Core) is configured to set amperage limits for the direct current distribution control module (PowerPack) 105. This will help protect the DC power source 205, overall DC power system, wiring, and DC devices 170, 171, 172 from damage. These over amperage values may be stored on the core processing module 100 (Core) and/or the direct current distribution control module (PowerPack) 105. In an embodiment, the direct current distribution control module 105 (PowerPack) includes self healing circuitry in the case of over power draw on circuit.

In one or more embodiments, the core processing module 100 (Core), includes circuitry to support a wired remote mount antenna. This antenna may be used to carry wireless data from a Bluetooth module, LTE module, GSM module, and/or any type of module configured to exchange communication in one of the following formats: Bluetooth, LTE, GSM or GPRS, CDMA, EDGE or EGPRS, EV-DO, WIFI, or IP. Use of said antenna will boost wireless range and communication between system and user mobile devices 130.

In one or more embodiments, the power distribution system modules 105, 110, 115, 160, and 100 include circuitry configured to enable the modules (e.g., embodied as a circuit board) to output a RGB color via an RGB LED. This will enable an enclosure (e.g., a housing comprised of plastic, metal, combinations thereof, etc.) of each module to glow from the inside. In an embodiment, the color that the module will emit will be defined by the user's mobile device 130 which will be connected wirelessly to the core processing module 100 (Core) and sent as a command over the network 135 to the target module 100, 105, 160, 110, or 115.

In an embodiment, the core processing unit is configured to store a secure data value(s) which will be used to authenticate user mobile devices 130 when the user mobile devices 130 attempt to connect to the core processing module 100 (Core). In this embodiment, this same secure data value(s) must be provided by all outside devices that try to connect to the core processing module 100 (Core) and/or network 135 before core processing module 100 and/or network 135 will allow the connection. This secure data value(s) could be username, password, numeric pin code, and/or biometric, for example.

In one or more embodiments, the dedicated touchscreen 120 and/or user mobile devices 130 may run native application code that supports one being the master and the other a slave. In the case of master-slave relationship, the master device 120, 130 is configured to override and/or lock out the slave 120, 130 device.

In one or more exemplary embodiments, the direct power control system includes multiple core processing modules 100 (Core). In this embodiment, the multiple core processing module 100 (Core) each communicate across the network 135 what actions they wish to perform. The core processing modules 100 (Core) each act as a source of entry into the network 135. So for example one core processing module 100 (Core) could have a Bluetooth module while an additional core processing module 100 (Core) may contain a LTE/GSM module. This will allow the direct power distribution system to be available from both Bluetooth and LTE/GSM in accordance with these embodiments.

In an embodiment, the user mobile devices 130 are configured to download all configuration data from the direct power distribution system and upload it to the application server 125 as a backup. This may act as a backup of data stored between modules 100, 105, 160, 110, 115 and 120 on the direct power distribution system.

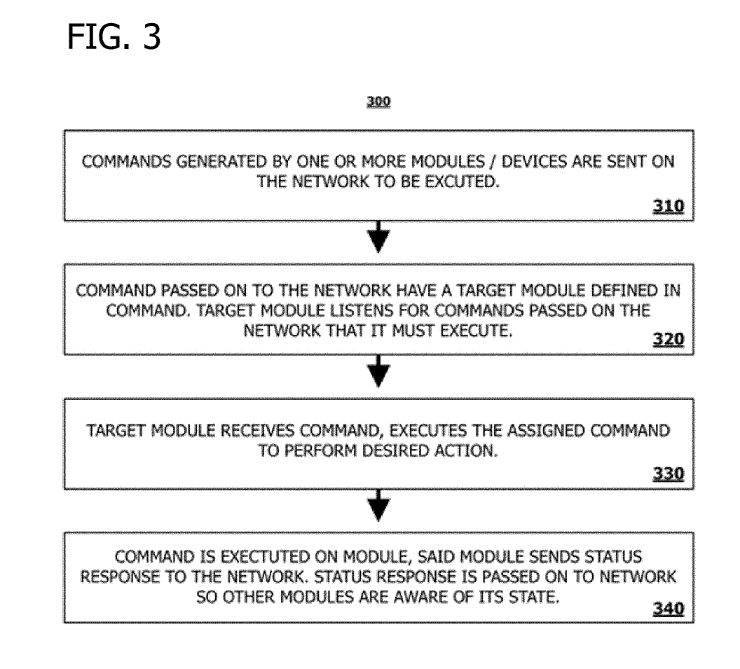

FIG. 3 illustrates an exemplary process 300 for performing operations using a user mobile device 130, external input trigger module (SwitchPack) 160, and/or dedicated screen. Briefly, the process 300 may include commands generated by modules and devices to be sent on the network 310, said command having a target module that listens for command 320, target module that receives the command to execute desired action 330, executed command is performed and module sends back status response so other modules on network are aware of its state 340.

In more detail the process 300 may include commands received from user mobile devices 130, dedicated touchscreen 120, and or external input trigger module (SwitchPack) 160. As part of the process 300 commands from external input trigger module (SwitchPack) 160 and dedicated touchscreen are delivered directly to network 135. Commands from user mobile devices 130 will be delivered and processed by the core processing module 100 (Core) then passed on to the network 135 for execution. Target modules 105, 160, 110, 115 will listen on the network 135 for commands they need to process 320, once a matching command reaches the correct module it will execute an action matched to the command 330, once the action has been performed said module will respond with a status code 340 that is passed on the network 135. The core processing module 100 (Core) will be listening for status messages on the network 135, it will then pass on information to connected user mobile devices 130. The dedicated touchscreen 120 will also be listening on the network 135 for status messages.

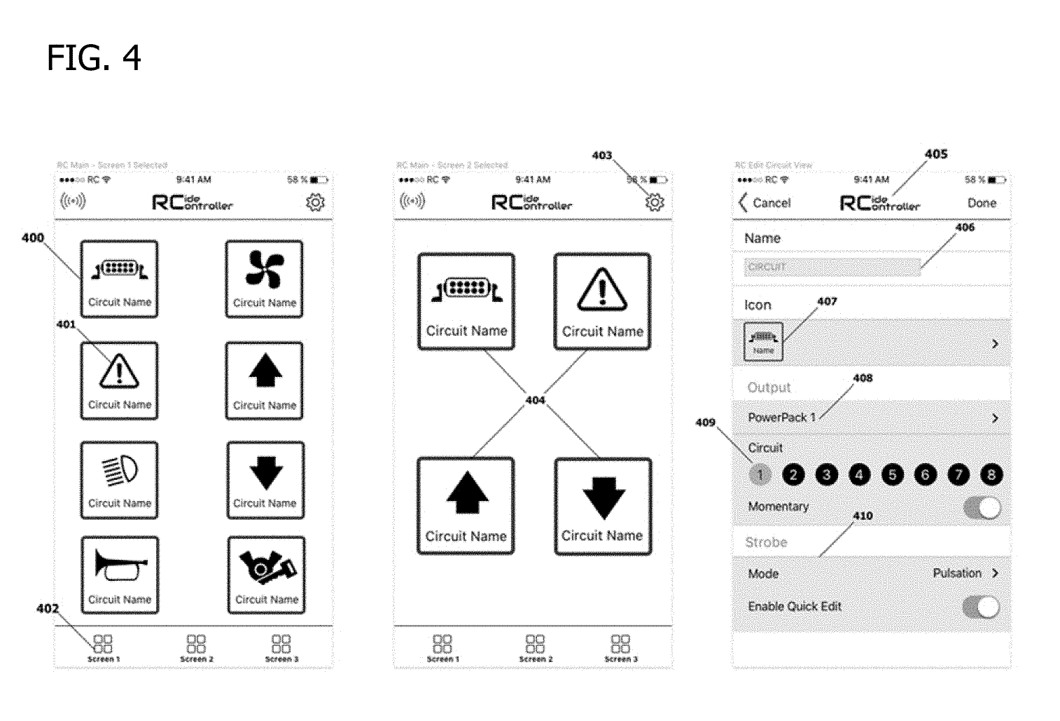

FIG. 4 illustrates a software application that manages a direct current electrical system. This application in some embodiments may run on user mobile devices 130 (FIG. 1) and/or Dedicated Touchscreen 120 (FIG. 1). The application will allow the user to customize the user interface to correspond to their desired layouts. The application can have one or more screens 402 (FIG. 4) which will show up as menu options in the footer of the application. Each screen will have one of the following configurations (4 zones, 8 zones, 16 zones, or some other type of custom pre-defined zones). Each zone 400 will have a corresponding output mapping that will assign it to a PowerPack 105, ColorPack 110, or RidePack 115 output. In some examples the zone 400 will have the ability to have an assigned a custom icon 401. The settings gear top right 403 will be used to manage all the UI customization within the native application. The Logo area 405 when selected will take the user to an advanced area of the application that will showcase more advanced features of the application to pull information from the direct current electrical system. When editing a specific zone area users will be able to define the circuit name 406, the custom icon 407, the assigned target module 100, 105, 160, 110, 115, and the output parameters (e.g., strobing, diming, etc.).

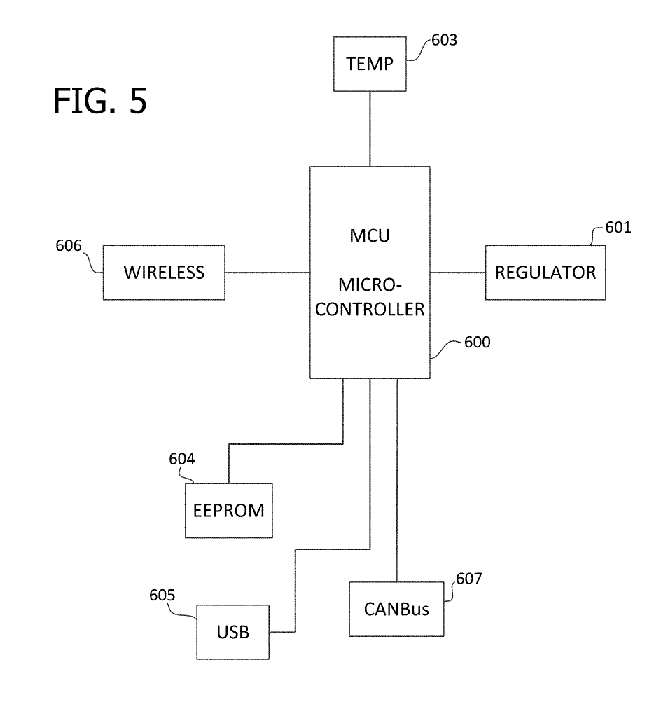

FIG. 5 illustrates an exemplary circuit comprising the core processing module 100 (Core), in an embodiment. The processor on the core processing module is located at 600. The temperature sensor 603 is used for measuring current temperature on the circuit board. The voltage regulator 601 is used to power the custom circuitry on the core processing module 100. All data that is stored on the core is stored in non-volatile memory 604. The core processing module communicates on the network 135 via the CANBus chip 607. The core processing module is programmed to run custom code that is uploaded via the USB-uart bootloader 605. The core processing module 100 communicates wirelessly to user mobile devices 130 using a wireless chip 606 (e.g., Bluetooth, LTE, cellular, etc.).

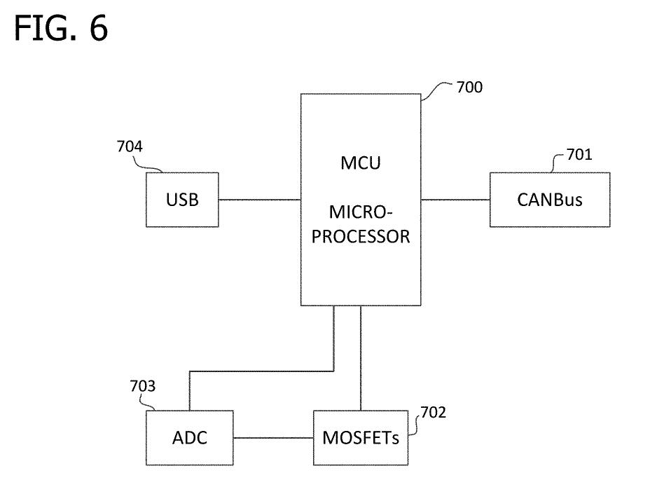

FIG. 6 illustrates an exemplary circuit comprising the PowerPack 105, in an embodiment. The processor on the PowerPack 105 is located at 700. The processor 700 on the PowerPack 105 runs (e.g., executes) the custom software to handle executing commands received from the CANBus chip 701 that communicates across the Network 135. The processor 700 manages computing and also contains built in storage memory. The CANBus chip 701 allows the other components on the PowerPack 105 to communicate on the Network 135. The MOSFETs 702 are what feed switched direct current power to the DC Devices 170. The analog-to-digital (A/D) converter 703 is used to measure current power usage across the MOSFET chips. This allows for real time feedback on what DC Devices 170 are pulling in amperage across the PowerPack 105. The PowerPack 105 is programmed to run custom code the custom code is uploaded via the USB-uart bootloader 704.

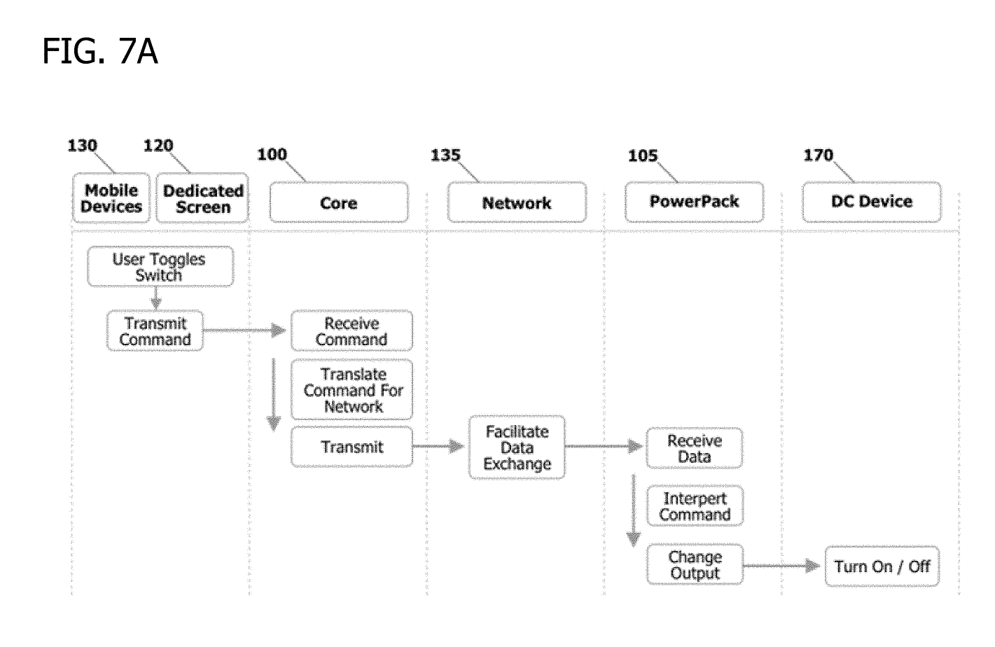

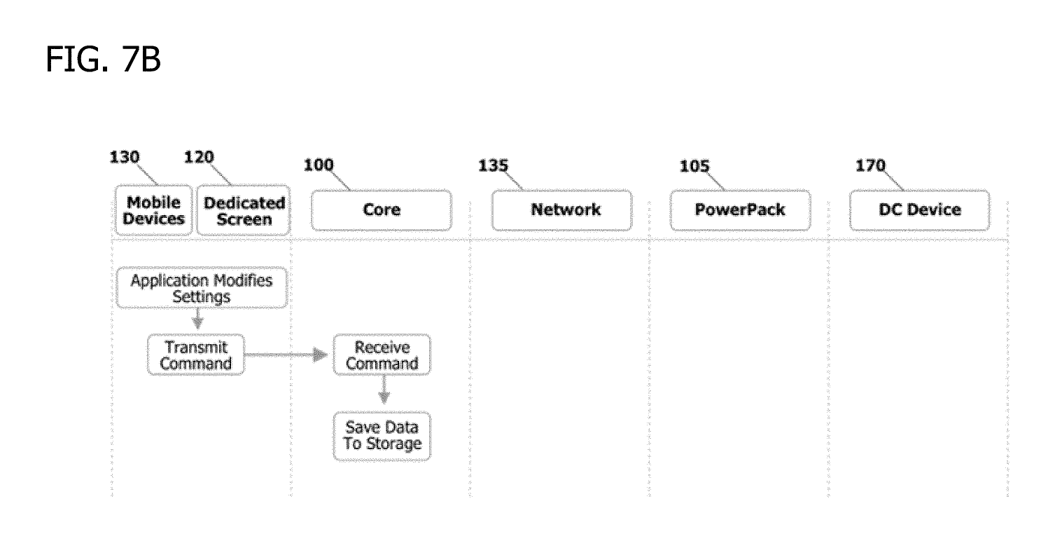

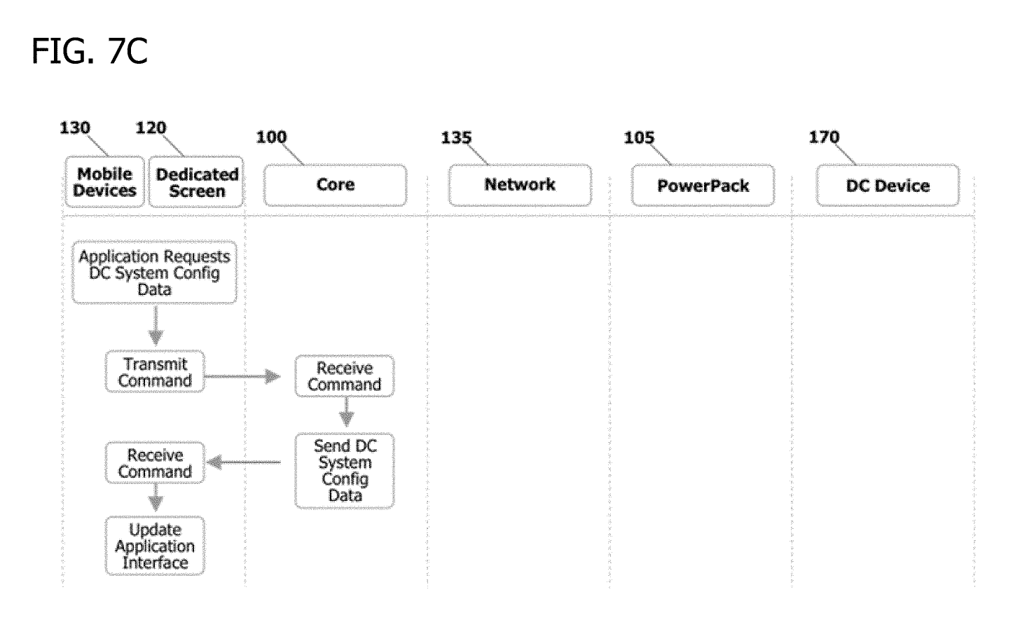

FIG. 7A illustrates an exemplary process of controlling a DC device 170 via direct current management system 90 in accordance with an embodiment of the disclosure.

FIG. 7B illustrates an exemplary process of modifying one or more settings of direct current management system 90.

FIG. 7C illustrates an exemplary process of updating a graphical user interface of the executing application based on configuration data in accordance with an embodiment of direct current management system 90.

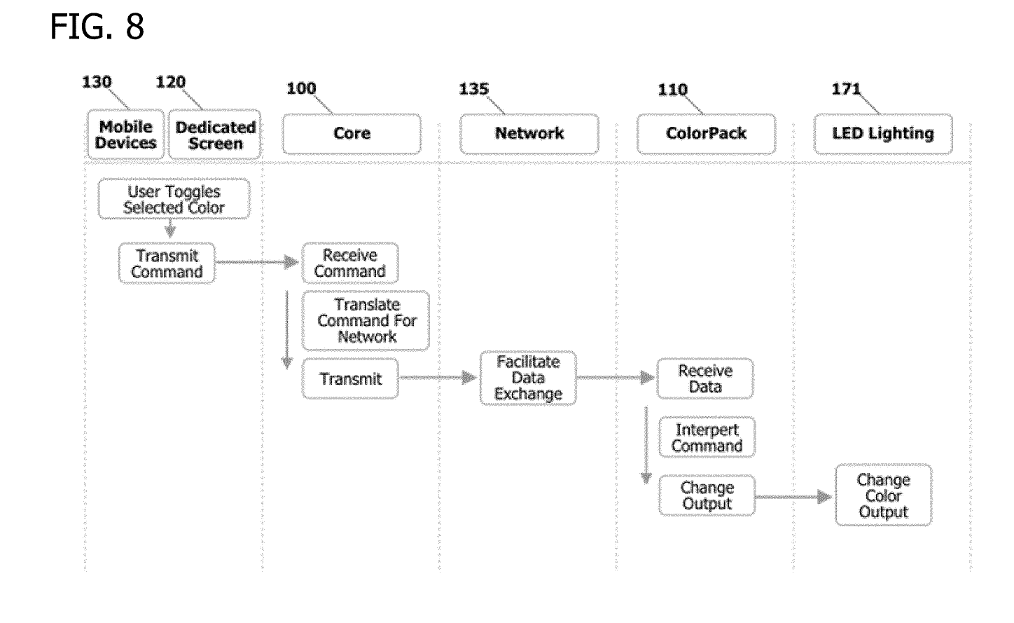

FIG. 8 illustrates an exemplary process of controlling a lighting device (e.g., LED 171) via direct current management system 90 in accordance with an embodiment of the disclosure.

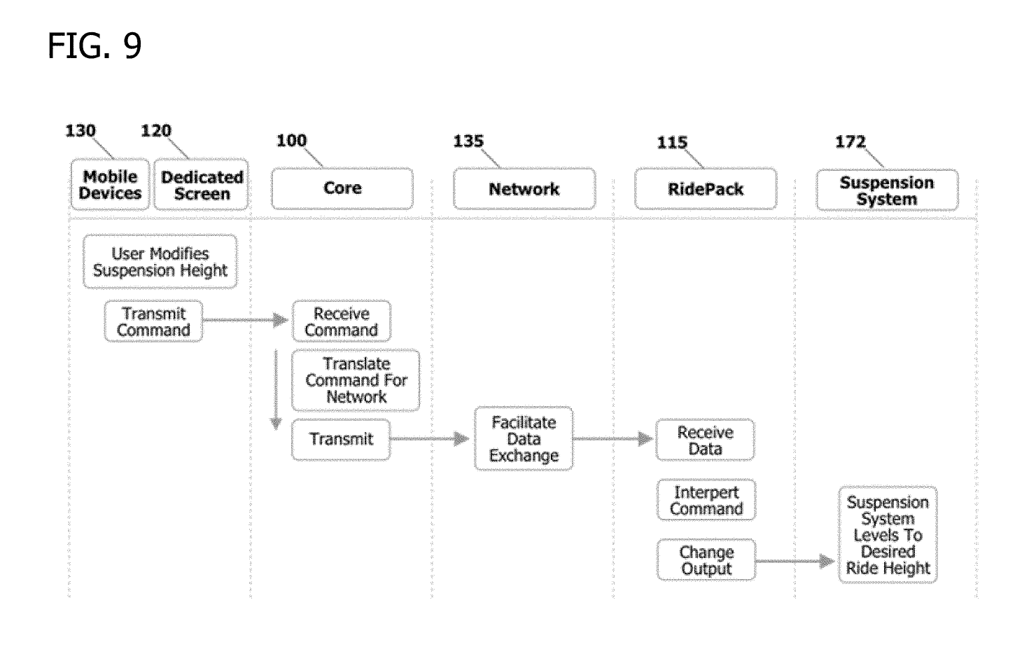

FIG. 9 illustrates an exemplary process of controlling suspension system 172 via direct current management system 90 in accordance with an embodiment of the disclosure.

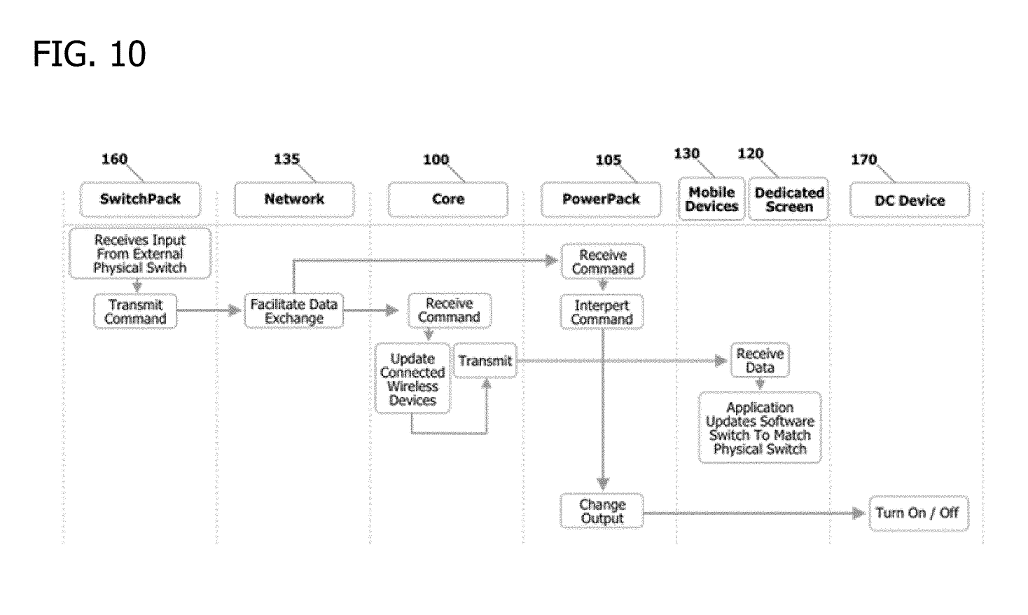

FIG. 10 illustrates an exemplary process of controlling devices via external input trigger module 160 in accordance with an embodiment of the disclosure.

The usage of a fabricated copper bus bar allows the PowerPack 105 to distribute more power across its printed circuit board. In an embodiment, the copper bus bar is bolted directly to the top of the PowerPack 105 printed circuit board. The bus bar is placed directly over the high current traces that run to the current switching circuit MOSFETs on the chip. This design allows the PowerPack 105 circuit board to deliver maximum power using a more cost effective 2 oz copper circuit board design.

In addition to the embodiments described above, embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, computer-readable storage media include both volatile and nonvolatile, removable and non-removable media implemented in any method or technology for storage of information such as computer readable instructions, data structures, program modules or other data. Computer storage media are non-transitory and include, but are not limited to, random access memory (RAM), read only memory (ROM), electrically erasable programmable ROM (EEPROM), compact disk ROM (CD-ROM), digital versatile disks (DVD), or other optical disk storage, solid state drives (SSDs), magnetic cassettes, magnetic tape, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes nonvolatile and volatile memory types. A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, SSDs, and the like.

Communication media typically embody computer readable instructions, data structures, program modules or other data in a modulated data signal such as a carrier wave or other transport mechanism and includes any information delivery media.

One or more aspects of the disclosure may be embodied in computer-executable instructions (i.e., software), routines, or functions stored in system memory or nonvolatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system, comprising:
a core module, the core module comprising:
a core module wired communication interface,
a wireless communication interface configured to communicatively couple the core module to a computing device,
one or more processors, and
a memory storage device storing processor-executable instructions and a ruleset;
a first module, the first module comprising a first module wired communication interface;
a second module, the second module comprising a second module wired communication interface; and
a communications network, wherein the core module wired communication interface, the first module wired communication interface, and the second module wired communication interface are communicatively coupled via the communications network;
wherein the first module is configured to send a first signal to the second module via the first module wired communication interface and the communications network;
wherein the second module is configured to:
receive the first signal via the communications network and the second module wired communication interface, and
alter an electrical output thereof to control an electrical device based on the first signal; and
wherein the processor-executable instructions, when executed by the one or more processors, configure the core module to:
monitor, via the core module wired communication interface, the communications network for the first signal,
determine a state of the electrical output of the second module by comparing the first signal to the ruleset, and
communicate, via the wireless communication interface, a second signal to the computing device based on the first signal and the ruleset,
wherein the second signal is at least in part representative of the determined state of the electrical output of the second module.

2. The system of claim 1, wherein the computing device comprises a mobile user device including at least one of a smartphone and a tablet computing device, and wherein the mobile user device has a graphical user interface (GUI) configured to present the determined state of the electrical output of the second module.

3. The system of claim 2, wherein the memory storage device of the core module is configured to store data representative of the GUI of the mobile user device, including icons, graphics, and placements thereof.

4. The system of claim 2, wherein the processor-executable instructions, when executed by the one or more processors, further configure the core module to:
receive, via the wireless communication interface, a user command from the mobile user device; and
communicate, via the core module wired communication interface and the communications network, the received command to a plurality of modules, including at least the first module and the second module,
wherein at least the second module is configured to alter the electrical output thereof to control the electrical device based on the communicated command.

5. The system of claim 2, wherein the processor-executable instructions, when executed by the one or more processors, further configure the core module to:
receive, via the wireless communication interface, a request from the mobile user device;
communicate, via the core module wired communication interface, the request on the communications network;
receive, via the core module wired communication interface and the communications network, one or more responses from a plurality of modules, including at least the first module and the second module, wherein the one or more responses are indicative of the modules being communicatively coupled to the communications network; and
send, via the wireless communication interface, a message to the mobile user device indicative of the modules being communicatively coupled to the communications network.

6. The system of claim 2, wherein the communicative coupling of the core module to the mobile user device is secure.

7. The system of claim 1, wherein the second module is electrically coupled to the electrical device.

8. The system of claim 7, wherein the core module, the first module, the second module, the communications network, and the electrical device are installed in at least one of a vehicle and a boat.

9. A method, comprising:
sending a first signal from a first module to a second module via a communications network;
receiving, by the second module, the first signal;
altering, by the second module, an electrical output thereof to control an electrical device based on the received first signal;
monitoring, by a core module, the communications network for the first signal;
determining, by the core module, a state of the electrical output of the second module by comparing the first signal to a ruleset stored on a memory storage device of the core module; and
communicating, by the core module, a second signal to a computing device via a wireless communication interface thereof, wherein the communicating is based on the first signal and the ruleset, and wherein the second signal is at least in part representative of the determined state of the electrical output of the second module.

10. The method of claim 9, further comprising presenting, by a graphical user interface (GUI) of the computing device, the determined state of the electrical output of the second module.

11. The method of claim 10, further comprising storing, by the core module, data representative of the GUI of the computing device, including icons, graphics, and placements thereof.

12. The method of claim 9, further comprising:
receiving, by the core module, a user command from the computing device;
communicating, by the core module via the communications network, the received user command to a plurality of modules, including at least the first module and the second module; and
altering, by the second module, the electrical output thereof to control the electrical device based on the communicated user command.

13. The method of claim 9, further comprising:
receiving, by the core module, a request from the computing device;
communicating, by the core module, the request on the communications network;
receiving, by the core module via the communications network, one or more responses from a plurality of modules, including at least the first module and the second module, wherein the one or more responses are indicative of the modules being communicatively coupled to the communications network; and
sending, by the core module, a message to the computing device indicative of the modules being communicatively coupled to the communications network.

14. The method of claim 9, further comprising securely communicatively coupling the core module to the computing device.

15. The method of claim 9, further comprising electrically coupling the second module to the electrical device.

16. The method of claim 9, wherein the core module, the first module, the second module, the communications network, and the electrical device are installed in at least one of a vehicle and a boat.

17. An electrical power input/output (I/O) device, comprising:
a plurality of outputs, wherein each output is configured to be electrically coupled to one or more electrical devices;
a plurality of inputs, wherein each input is configured to be electrically coupled to at least one of a sensor and a switch;
a plurality of metal-oxide-semiconductor field-effect transistors (MOSFETs), wherein a source terminal of each MOSFET is electrically coupled to a corresponding one of the plurality of inputs, and wherein a drain terminal of each MOSFET is electrically coupled to a corresponding one of the plurality of outputs;
a Controller Area Network (CAN) bus network interface;
one or more processors; and
a memory storage device storing processor-executable instructions and data representative of an amperage rating limit for each of the plurality of outputs;
wherein the processor-executable instructions, when executed by the one or more processors, configure the one or more processors to:
receive a real-time reading from a first MOSFET of the plurality of MOSFETS, wherein the real-time reading is indicative of a present current draw of a first output of the plurality of outputs, wherein the first output is the corresponding one of the plurality of outputs electrically coupled to the drain terminal of the first MOSFET;
compare the received reading to a first amperage threshold value for the first MOSFET, wherein the first amperage threshold value is stored in the memory storage device;
control the first MOSFET to shutoff the first output by preventing electrical current from flowing from the drain terminal of the first MOSFET to the first output when the received reading exceeds the first amperage threshold value; and
send a first message via the CAN bus network interface, wherein the first message comprises an indication that the first output is shutoff, and
wherein the sending of the first message enables a core module to update a graphical user interface (GUI) of a mobile user device to indicate that the first output is shutoff.

18. The electrical power I/O device of claim 17, wherein the processor-executable instructions, when executed by the one or more processors, further configure the one or more processors to:
receive, via the CAN bus network interface, a second message, wherein the second message comprises an updated first amperage threshold value; and
overwrite the first amperage threshold value stored in the memory storage device with the updated first amperage threshold value.

19. The electrical power I/O device of claim 17, wherein the processor-executable instructions, when executed by the one or more processors, further configure the one or more processors to send a second message via the CAN bus network interface, wherein the second message comprises the real-time reading, and wherein the second message enables the core module to update the GUI of the mobile user device to display the real-time reading.

20. The electrical power I/O device of claim 17, wherein the processor-executable instructions, when executed by the one or more processors, further configure the one or more processors to:
receive, via the CAN bus network interface, a second message, wherein the second message comprises a user command from the mobile user device to shutoff the first output; and
control the first MOSFET to shutoff the first output by preventing electrical current from flowing from the drain terminal of the first MOSFET to the first output upon the receiving of the second message.
